(19) United States
(12) Patent Application Publication
(10) Pub. No.: US 2014/0135132 A1
(43) Pub. Date: May 15, 2014

(54) NON-CHATTERING BALL DETENT TORQUE LIMITER

(71) Applicant: MOOG INC., East Aurora, NY (US)

(72) Inventors: Kerry Randall KOHUTH, Riverton, UT (US); Derek PEDERSEN, South Jordan, UT (US); Scott A. LEE, Erda, UT (US)

(73) Assignee: MOOG INC., East Aurora, NY (US)

(21) Appl. No.: 13/829,867

(22) Filed: Mar. 14, 2013

Related U.S. Application Data
(60) Provisional application No. 61/724,989, filed on Nov. 11, 2012.

(51) Int. Cl. F16D 7/00

(52) U.S. Cl. CPC F16D 7/005
USPC 464/36

(57) ABSTRACT

The present invention improves a ball-detent torque-limiting assembly by providing breakout means for maintaining an axial separation distance between opposing pocketed surfaces of the assembly once the balls have rolled out of their pockets, wherein the axial separation distance maintained by the breakout means is at least as great as the diameter of the balls. The breakout means assumes the axially directed spring load that urges the opposing pocketed surfaces together, thereby preventing the balls from entering and exiting the pockets in quick and violent succession following breakout and avoiding damage to the torque-limiting assembly. The torque-limiting assembly is resettable by counter-rotation following a breakout event.

### CROSS-REFERENCE TO RELATED APPLICATIONS

The present application claims priority of U.S. Provisional Patent Application No. 61/724,989 filed Nov. 11, 2012, the entire contents of which are incorporated herein by reference.

### FIELD OF THE INVENTION

The present invention relates generally to electromechanical actuation of aircraft control surfaces, and more particularly to torque limiters designed to prevent transmission of excessive torque and load after an electromechanical actuator for moving an aircraft control surface has encountered a hard mechanical stop.

### BACKGROUND OF THE INVENTION

Aircraft control surfaces, for example flaps located on the trailing edge of a fixed wing, slats located on a leading edge of a fixed wing, spoiler panels, aileron surfaces, and the like, have traditionally been actuated by hydraulic actuation systems. More recently, electromechanical actuators (“EMAs”) have gained acceptance in the aviation industry for adjusting the position of control surfaces. EMAs are designed to sweep through a given stroke, linear or rotary, but must have definite points where the stroke must start and end. In practice, two sets of endpoints are defined: one set defines the electrical stroke and the other the mechanical stroke. In normal operation, EMAs are controlled by sophisticated integral or remote electronics over the electrical stroke. However, conditions may arise where an errant command results in the EMA being driven beyond the normal electrical stroke endpoint into a mechanical stroke endpoint. The endpoints that define the mechanical stroke are usually hard mechanical stops. Aircraft manufacturers require that the EMA contain the EMA stroke to prevent possible damage to the airframe or control surfaces. Because of usual space constraints in aircraft, extra room to include “soft” mechanically cushioned stops is not available. If an EMA is driven at sufficient rate into a mechanical end stop either during an in-flight event or as a result of a rigging error during assembly, significant damage usually occurs. After a “shearout” device is employed, and after an event, the EMA is rendered inoperative. A costly overhaul process is required to replace parts and return the unit to service.

It is known to use a rotary ball detent mechanism in an EMA system to limit the torque transmitted from an input gear to an output gear to a chosen maximum torque. The input and output gears are axially aligned on a drive shaft. After a stop is encountered, the rotary ball detent mechanism disconnects the driving inertia from the load path at levels that prevent damage. Conventional ball detent mechanisms employ a series of metal balls all in the same plane that are equally spaced around a circumference about the drive shaft. The balls are held between two circular plates each having an array of pockets to hold the balls. The spacing between the plates is therefore the ball diameter less the depth of the opposing ball pockets. A cage between the plates having a thickness slightly less than the plate spacing is usually employed to maintain even angular ball spacing. The plates and balls are held on the drive shaft by relatively heavy axial spring loading. Under normal operation, all parts rotate together at a commanded speed. The magnitude of the spring loading, the size and number of balls, and depth and shape of pocket dictate the torque limit of the device.

The breakout load or torque limit is selected to be greater than the maximum operating load so that it never “trips” during normal operation, but less than loads that would cause damage to the EMA. With the conventional ball detent mechanism described above, after a breakout or hard stop condition is encountered, one plate is brought to an abrupt stop while the other continues to rotate as the set of balls, in unison due to the cage, roll out of the pockets and onto the flat opposing surfaces of the two circular plates. The shaft is usually rotating at least several hundred—and often up to several thousand—revolutions per minute. The control electronics cannot sense a problem or act on a problem instantaneously, so the EMA's motor is driven for some fraction of a second after breakout. For example, if initial speed is 2400 RPM and six balls are used, with an assumed time of 200 msec before the motor can be turned OFF, 8 revolutions occur. Therefore, the balls that breakout of the initial pockets then encounter 48 more events of rolling into and out of subsequent pockets in the direction of rotation. With the high spring force and the abrupt shape of the pockets, the continued motion of the balls rolling into and out of pockets results in a very violent series of events. The balls experience very high and repeated impact loading and may fracture. Also, the edges of the pockets in the plates may generate harmful debris. Tests have shown significant damage to ball pockets after several encounters. The audible noise from the conventional approach is a loud chatter that may be described as “machine-gun-like.”

### SUMMARY OF THE INVENTION

The present invention solves the damage and noise problems associated with a breakout event experienced by a conventional torque-limiting assembly. Moreover, the present invention provides a torque-limiting assembly that is easily reset for continued operation after a breakout event.

The present invention provides a ball-detent torque-limiting assembly with breakout means for maintaining an axial separation distance between opposing pocketed surfaces of the assembly once the balls have rolled out of their pockets, wherein the axial separation distance maintained by the breakout means is at least as great as the diameter of the balls. The breakout means assumes the axially directed spring load that urges the opposing pocketed surfaces together, thereby preventing the balls from entering and exiting the pockets in quick and violent succession following breakout and avoiding damage to the torque-limiting assembly.

In one embodiment, the breakout means comprises an angular array of cooperating pairs of ramp members respectively protruding from one of the pocketed surfaces and from a facing surface of a cage retaining the balls. In another embodiment, the breakout means includes a plurality of rollers in an angular array spaced radially relative to the balls and opposing ball pockets to avoid alignment with the ball pockets. In both embodiments, the breakout means is reversible to reset the assembly by commanding a reverse rotation in an angular direction opposite the breakout direction.

### BRIEF DESCRIPTION OF THE DRAWING VIEWS

Features and advantages of embodiments of the present disclosure will become apparent by reference to the following detailed description and drawings, in which:

FIG. 1 is a perspective view of a torque-limiting assembly formed in accordance with a first embodiment of the present invention;

FIG. 2 is an exploded perspective view of the torque-limiting assembly shown in FIG. 1, looking generally in a first axial direction;

FIG. 3 is an exploded perspective view of the torque-limiting assembly shown in FIG. 1, looking generally in a second axial direction opposite the first axial direction;

FIG. 4 is a perspective view of an input gear of the torque-limiting assembly shown in FIG. 1;

FIG. 5 is an axial plan view of the input gear shown in FIG. 4;

FIG. 6 is a perspective view of a cage, balls, and backing plate of the torque-limiting assembly shown in FIG. 1;

FIG. 7 is an axial plan view of the cage, balls, and backing plate shown in FIG. 8;

FIG. 8 is a cross-sectional view of the torque-limiting assembly shown in FIG. 1, in normal operating condition;

FIG. 9 is a cross-sectional view of the torque-limiting assembly shown in FIG. 1, in breakout operating condition;

FIG. 10 is a perspective view illustrating the torque-limiting assembly of FIG. 1 after breakout;

FIG. 11 is another perspective view illustrating the torque-limiting assembly of FIG. 1 after breakout;

FIG. 12 is an exploded perspective view of a torque-limiting assembly formed in accordance with a second embodiment of the present invention, looking generally in a first axial direction;

FIG. 13 is an exploded perspective view of the torque-limiting assembly shown in FIG. 12, looking generally in a second axial direction opposite the first axial direction;

FIG. 14 is a perspective view of an input gear of the torque-limiting assembly shown in FIGS. 12-13;

FIG. 15 is an axial plan view of the input gear shown in FIG. 14;

FIG. 16 is an enlarged perspective view of the backing plate shown in FIG. 12;

FIG. 17 is a perspective view of an outer cage, balls, inner cage, rollers and backing plate of the torque-limiting assembly shown in FIGS. 12-13;

FIG. 18 is an axial plan view of the outer cage, balls, inner cage, rollers and backing plate shown in FIG. 17;

FIGS. 19-25 are a sequential series of schematic axial views showing the torque-limiting assembly of the second embodiment as it experiences breakout and then reset.

### DETAILED DESCRIPTION OF THE INVENTION

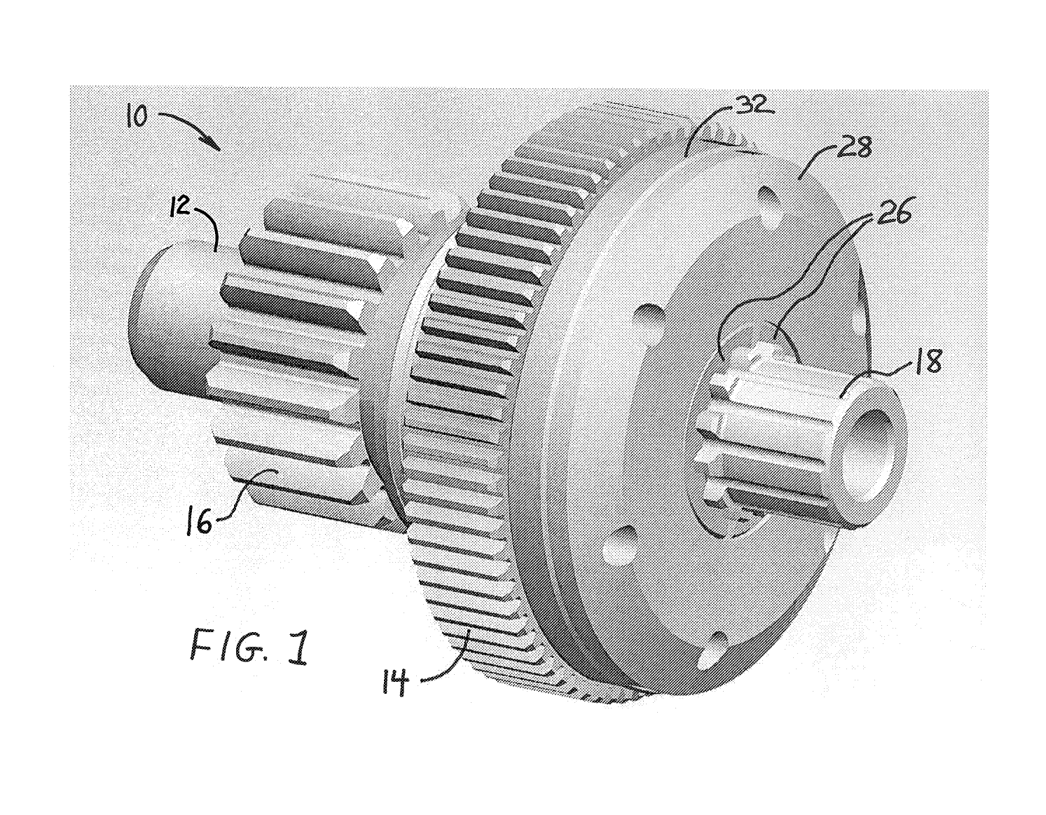

FIG. 1-3 depict a torque-limiting assembly 10 formed in accordance with a first embodiment of the present invention. Assembly 10 has utility in an EMA drive system for actuating an aircraft control surface, e.g. a spoiler panel, flap, slat or other aircraft control surface.

Assembly 10 generally comprises an elongated shaft 12 supporting an input gear 14 and an output gear 16. Shaft 12 includes a splined end 18 provided with a circumferential retaining groove 19. Assembly 10 further comprises a spring 20, washers 22, a collar 24, retainer clips 26, and a backing plate 28 all mounted on shaft 12.

Output gear 16 is mounted on shaft 12 for rotation with the shaft. In the context of the present specification, “mounted on” is meant in a broad sense to include a part that is separately manufactured and slid onto shaft 12, as well as a part that is integrally formed on shaft 12.

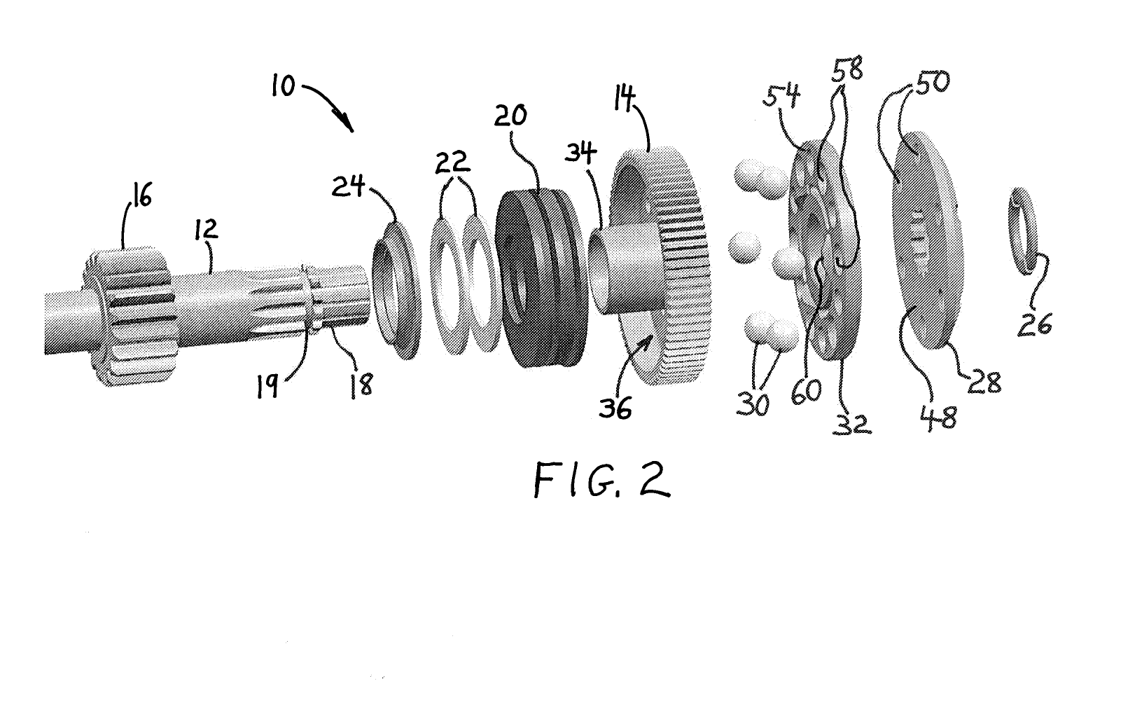

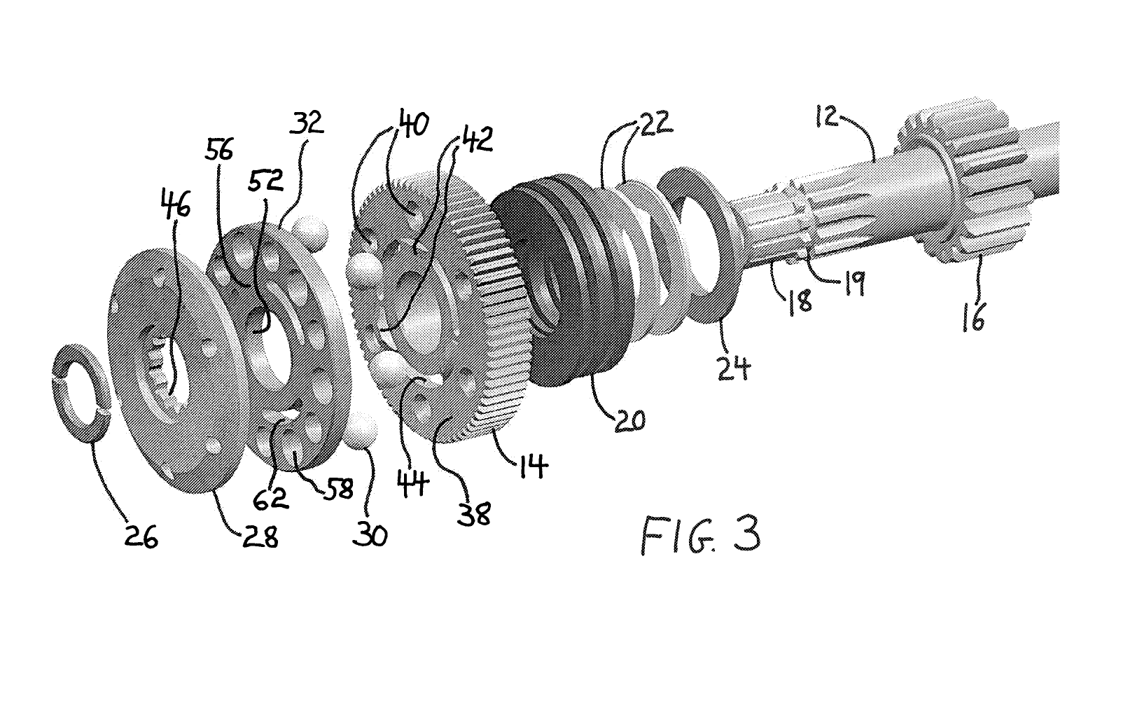

Input gear 14 is mounted on shaft 12 so as to be rotatable about the shaft axis relative to the shaft, and axially displaceable along the shaft in first and second opposite axial directions. Input gear 14 includes a driving surface 38 facing in a first axial direction toward splined end 18 of shaft 12. Driving surface 38 may be an integral surface of input gear 14 as shown in FIG. 3, or it may be a surface of a drive plate (not shown) that is manufactured separately from input gear 14. Integrating driving surface 38 with input gear 14 is advantageous because it saves axial space. Driving surface 38 includes a plurality of ball pockets 40 angularly spaced about the axis of shaft 12. As best seen in FIG. 2, input gear 14 may include an annular recess 36 on the side opposite from driving surface 38, and a cylindrical mounting sleeve 34 extending in a second axial direction away from splined end 18 and toward output gear 16.

Backing plate 28 includes a toothed opening 46 enabling the backing plate to be mounted on splined end 18 of shaft 12 such that the backing plate rotates with the shaft about the shaft axis. Backing plate 28 is constrained against axial displacement along shaft 12 in the first axial direction by C-shaped retainer clips 26 received in retaining groove 19. Backing plate 28 includes a detent surface 48 opposing driving surface 38 and having a plurality of ball pockets 50 angularly spaced about the shaft axis.

Spring 20, which may be embodied as a Belleville spring pack, may be mounted over cylindrical sleeve 34 of input gear 14 for partial receipt within annular recess 36 for an axially-compact biasing arrangement. One end of spring 20 bears against axially-fixed output gear 16 by way of washers 22 and collar 24, while the other end of spring 20 bears against axially-displaceable input gear 14. As may be understood, spring 20 is arranged to provide an axially-directed load urging input gear 14 in the first axial direction toward backing plate 28.

Assembly 10 further comprises a cage 32 having a central mounting hole 52 for mounting the cage on shaft 12. Cage 32 is mounted on shaft 12 between driving surface 38 and detent surface 48. Cage 32 includes a driven surface 54 facing driving surface 38, and a braking surface 56 facing detent surface 48. Cage 32 further includes a plurality of ball openings 58 therethrough. Ball openings 58 are angularly spaced about the axis of shaft 12. Assembly 10 also includes a plurality of balls 30 of uniform diameter received in ball openings 58. The diameter of balls 30 is greater than the axial thickness of cage 32 (i.e. the distance from driven surface 54 to braking surface 56), such that protruding spherical caps of each ball 30 project into a ball pocket 40 in driving surface 38 and an opposing ball pocket 50 in detent surface 48. Under normal torque loading conditions, the bias of spring 20 maintains the assembly in the described arrangement.

When a hard mechanical stop event results in abrupt rotational stoppage of shaft 12 and output gear 16, the motor of the EMA momentarily continues to drive input gear 14. When this occurs, assembly 10 is designed to allow slippage between input gear 14 and shaft 12 to prevent torque transmission to shaft 12 in excess of a predetermined torque limit. In accordance with the present invention, assembly 10 comprises breakout means for causing and maintaining axial separation of driving surface 38 from detent surface 48 by a distance at least as great as the diameter of balls 30 during a mechanical stop event, whereby balls 30 are not repeatedly slammed into pockets 40 and 50 as input gear 14 continues to rotate.

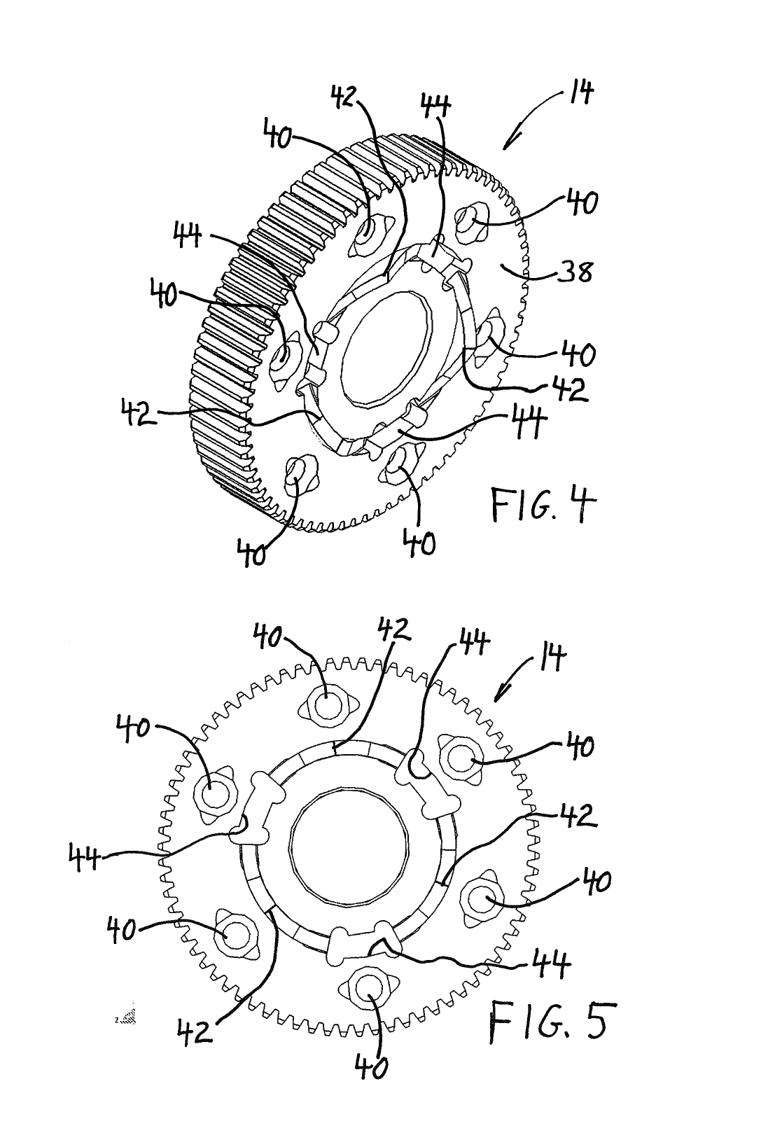

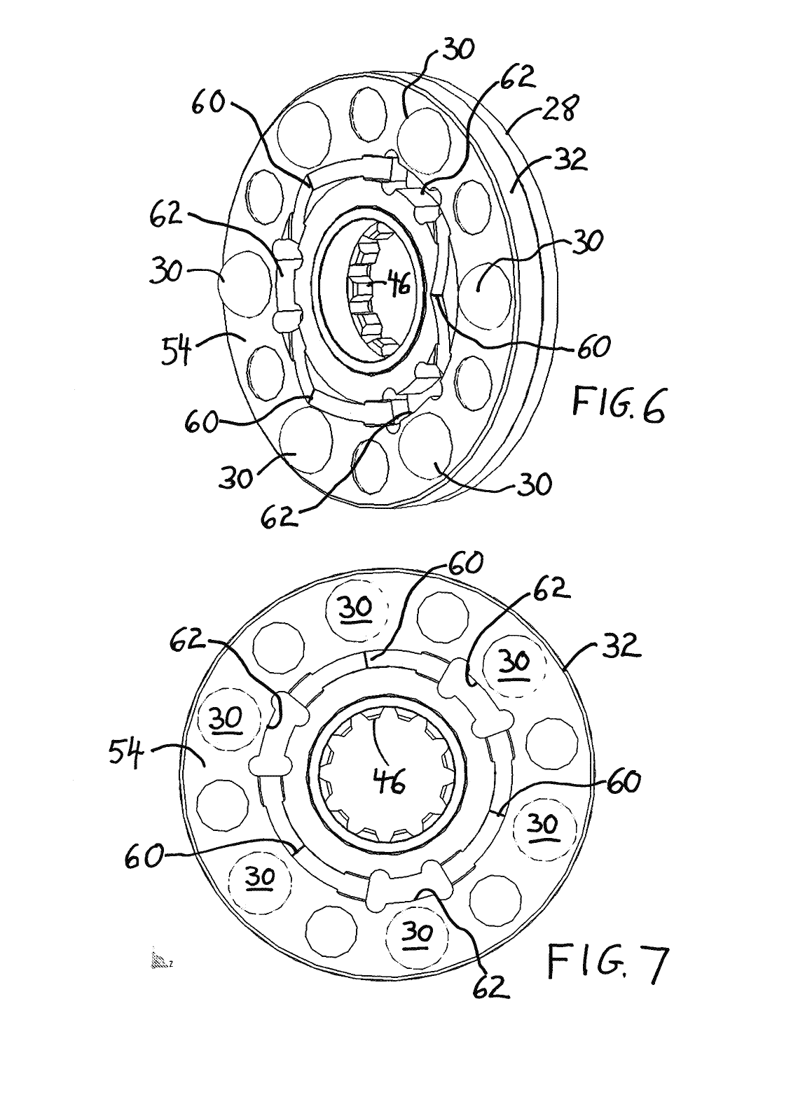

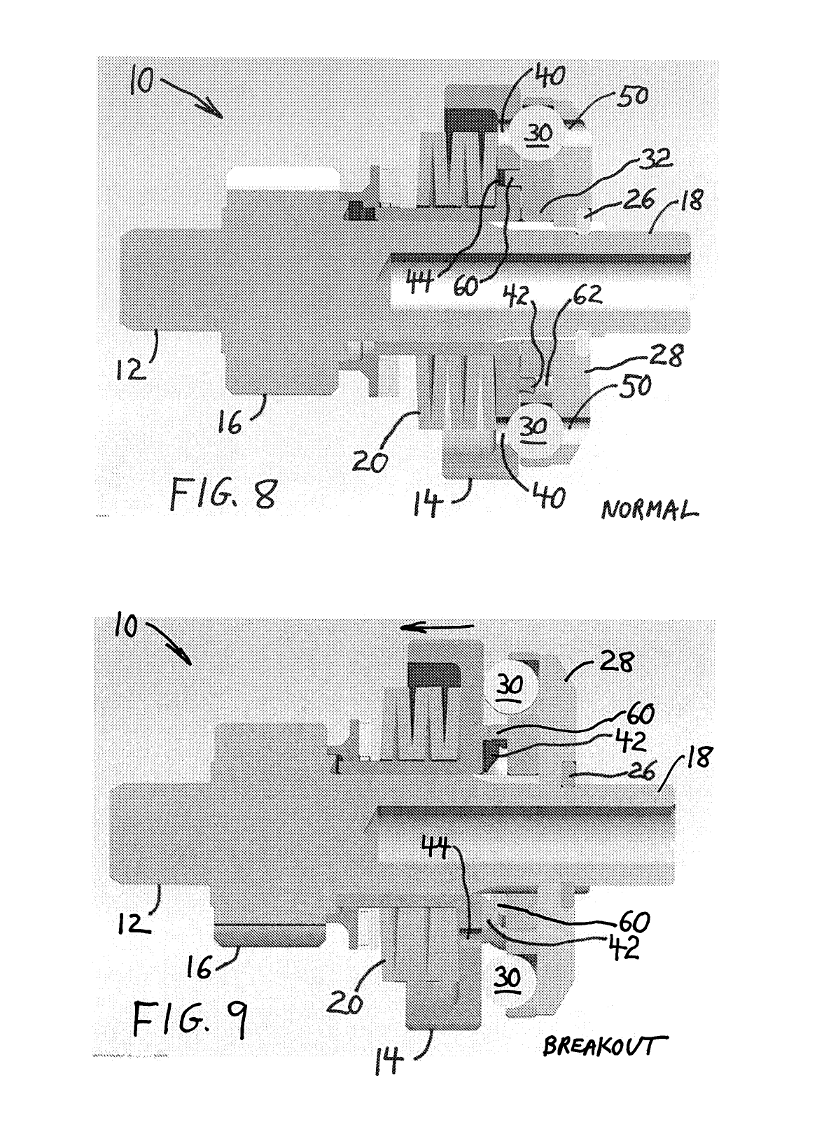

Reference is made to FIGS. 4-11 for explanation of the breakout means of the first embodiment. In the first embodiment, the breakout means includes a circular series of peaked ramps 42 protruding out of driving surface 38, and a corresponding circular series of peaked ramps 60 protruding out of driven surface 54. Peaked ramps 42 are angularly spaced about the axis of shaft 12 and are separated from one another by arc-shaped slots 44. Likewise, peaked ramps 60 are angularly spaced about the axis of shaft 12 and are separated from one another by arc-shaped slots 62. The circle defined by ramps 42 and slots 44, and the circle defined by ramps 60 and slots 62, have the same radius. In the depicted embodiment, the ramp-slot circles are radially within a circle defined by balls 30, however an arrangement in which the ramp-slot circles are radially outside the ball circle is within the scope of the invention. Under normal condition, ramps 42 are received in slots 62 and ramps 60 are received in slots 44; this condition can be seen in the cross-sectional view of FIG. 8.

When a hard mechanical stop is encountered, backing plate 28 stops rotating along with shaft 12 and output gear 16. However, input gear 14 continues to be driven momentarily due to delay in stopping the EMA motor, and toque is transmitted to shaft 12. When the torque limit is exceeded, input gear 14 will rotate relative to shaft 12 and backing plate 28. As this happens, balls 30 will roll out of pockets 40 in driving surface 38; this is best seen in FIGS. 9 and 11. The balls will also roll out of pockets 50 in detent surface 48 of backing plate 28 because the backing plate is rotationally stopped with shaft 12. As the balls 30 roll out onto the flat driving surface 38 and flat detent surface 48, they displace input gear 14 slightly in the second axial direction (away from splined end 18) against the bias of spring 20.

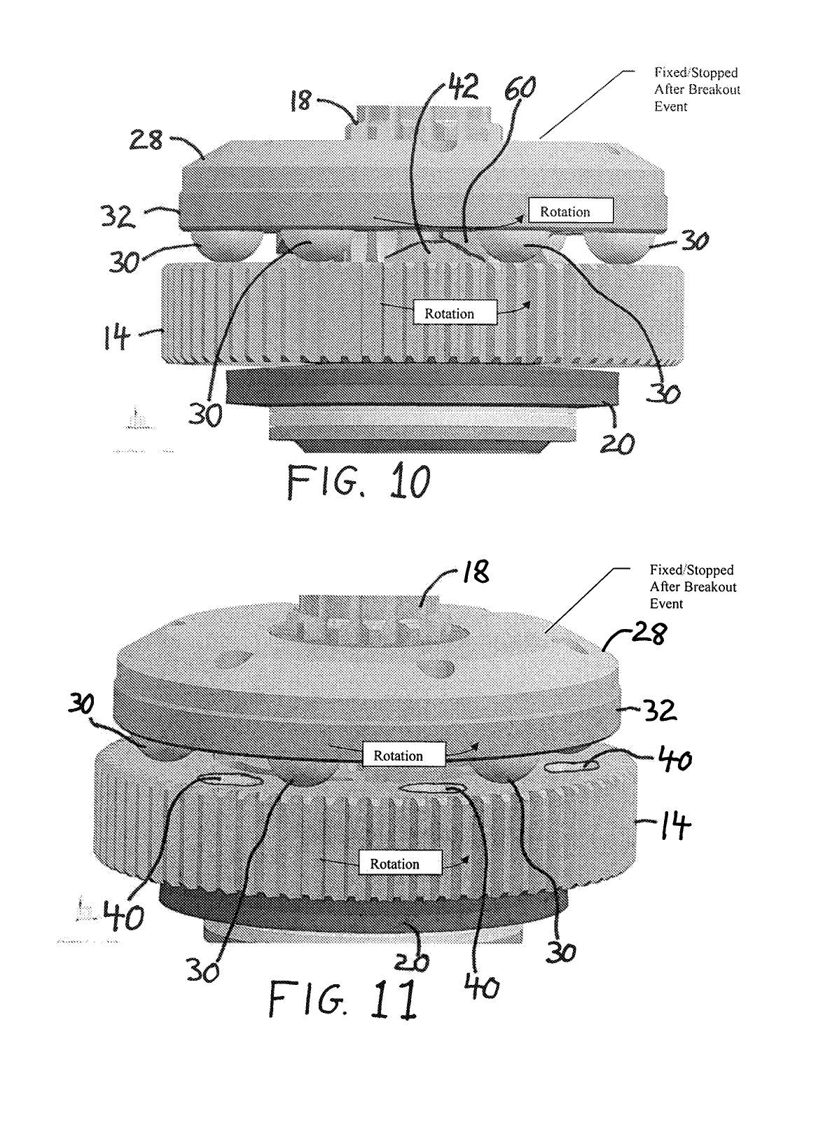

FIGS. 9 and 10 show that simultaneously with the breakout of balls 30 from pockets 40, complementary sloped surfaces of ramps 42 and 60 engage one another, thereby converting the relative rotary motion between input gear 14 and cage 32 into further axial displacement of input gear 14 in the second axial direction. The cooperative engagement of ramps 42 and 60 causes the driving surface 38 and detent surface 48 to be separated by an axial distance greater than the diameter of balls 30, such that the balls do not bear the load of axial spring 20. The engaged ramps 42 and 60 also cause cage 32 to rotate in unison with input gear 14 (or with a separate driving plate, if a separate driving plate is used as mentioned above). This prevents the balls from reaching another pocket 40. The balls 30 are unloaded and rotate with input gear 14 (or with a separate driving plate) and with cage 32. Cage 32 is also displaced in the first axial direction such that its braking surface 56 comes into frictional contact with detent surface 48 of stationary backing plate 28, thereby providing braking action which gently slows the rotating parts.

If a breakout occurs, the control electronics will eventually command the EMA's motor to stop. The present invention will then allow a simple reset of the assembly 10 by commanding a reverse rotary motion of input gear 14 to cause balls 30 to roll back into the original pockets 40, 50. The invention handles a breakout event with little or no damage to the system.

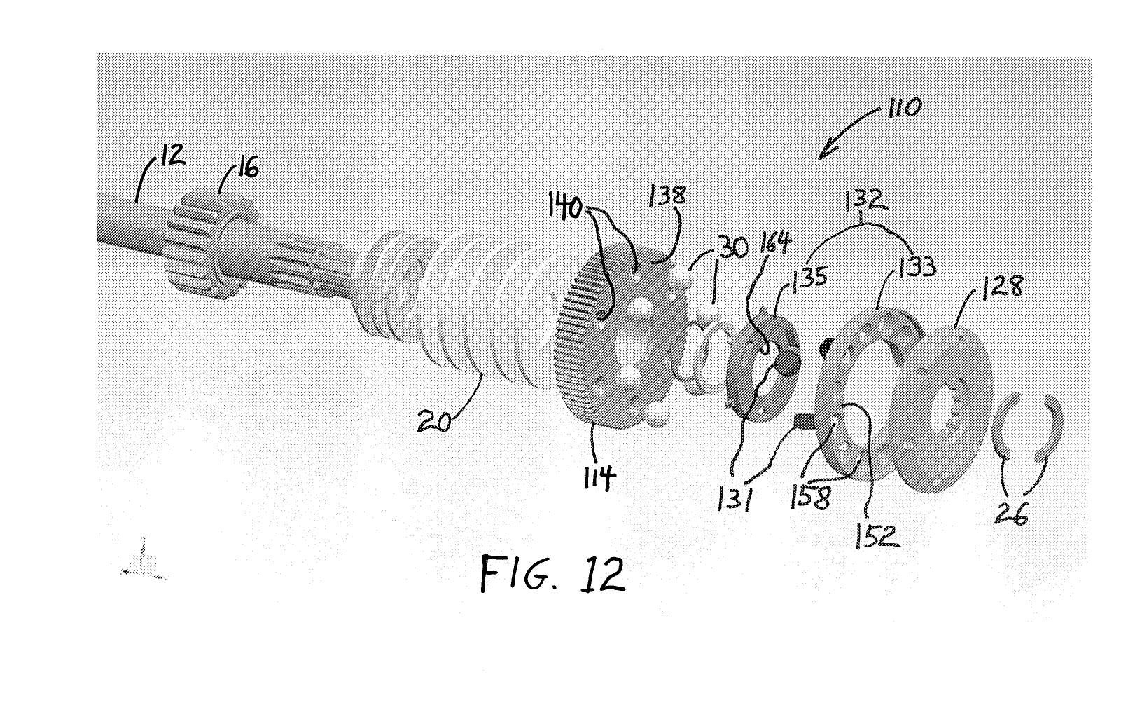

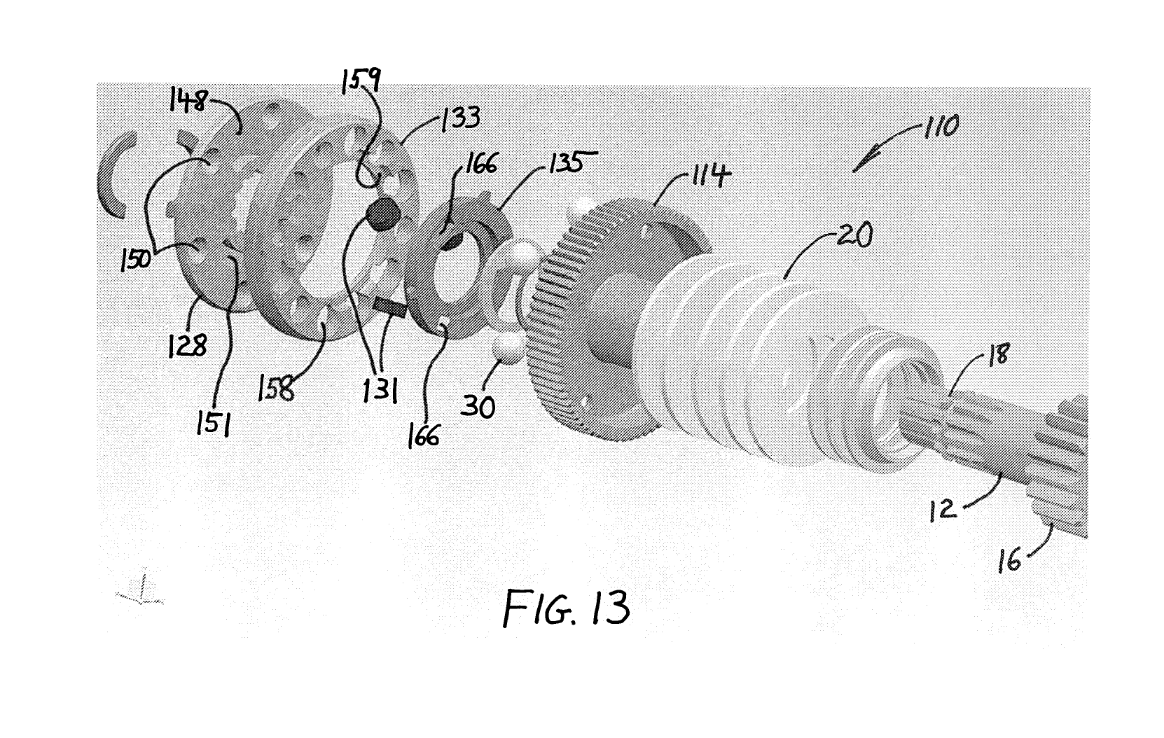

FIGS. 12 and 13 illustrate a torque-limiting assembly 110 formed in accordance with a second embodiment of the present invention that employs an alternative breakout means. Assembly 110 comprises an input gear 114, output gear 16, a backing plate 128, a composite cage 132, and a plurality of balls 30 arranged and mounted on drive shaft 12 and biased by spring 20 in a manner similar to the first embodiment.

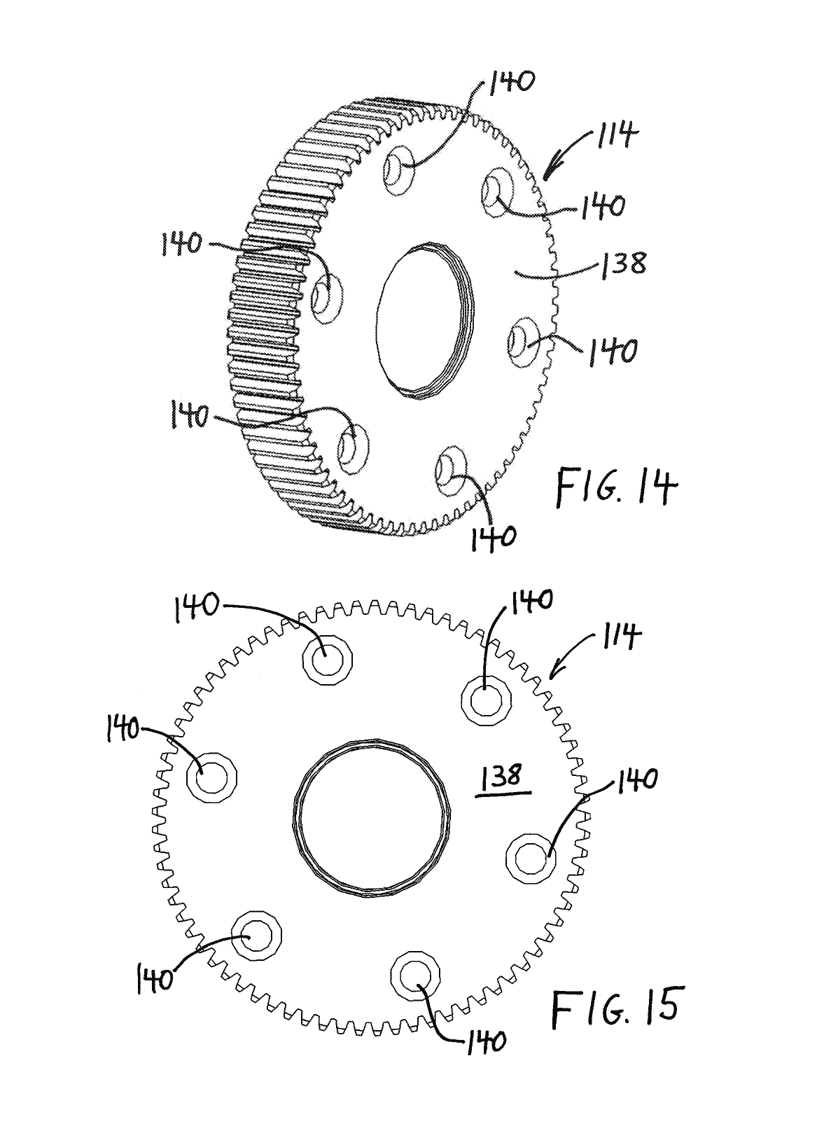

FIGS. 14 and 15 show input gear 114 in detail. Input gear 114 includes a driving surface 138 facing in the first axial direction toward splined end 18 of shaft 12. As in the first embodiment, driving surface 138 may be an integral surface of input gear 114 as shown in FIG. 13, or it may be a surface of a separately-manufactured drive plate (not shown). Driving surface 138 includes a plurality of ball pockets 140 angularly spaced about the axis of shaft 12. In contrast to driving surface 38 of the first embodiment, driving surface 138 does not have ramps and slots.

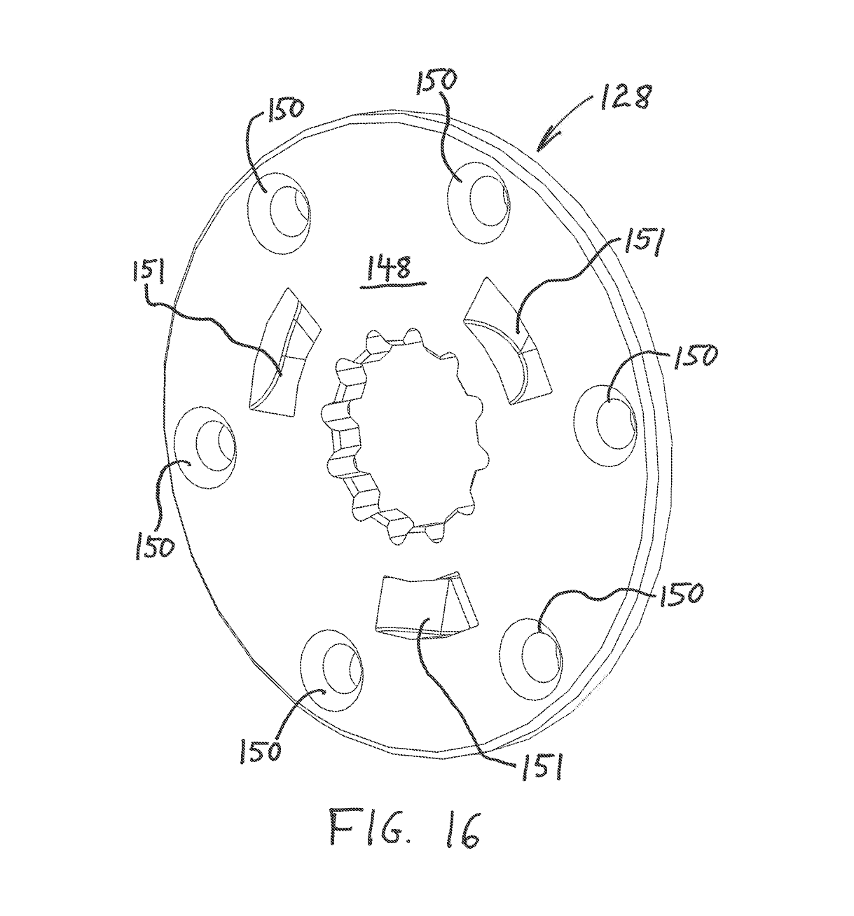

Backing plate 128, shown in FIG. 16, includes a detent surface 148 opposing driving surface 138 and having a plurality of ball pockets 150 angularly spaced about the shaft axis. Detent surface 148 is also provided with a plurality of curved roller pockets 151 angularly spaced about the axis of shaft 12 radially inward from ball pockets 150.

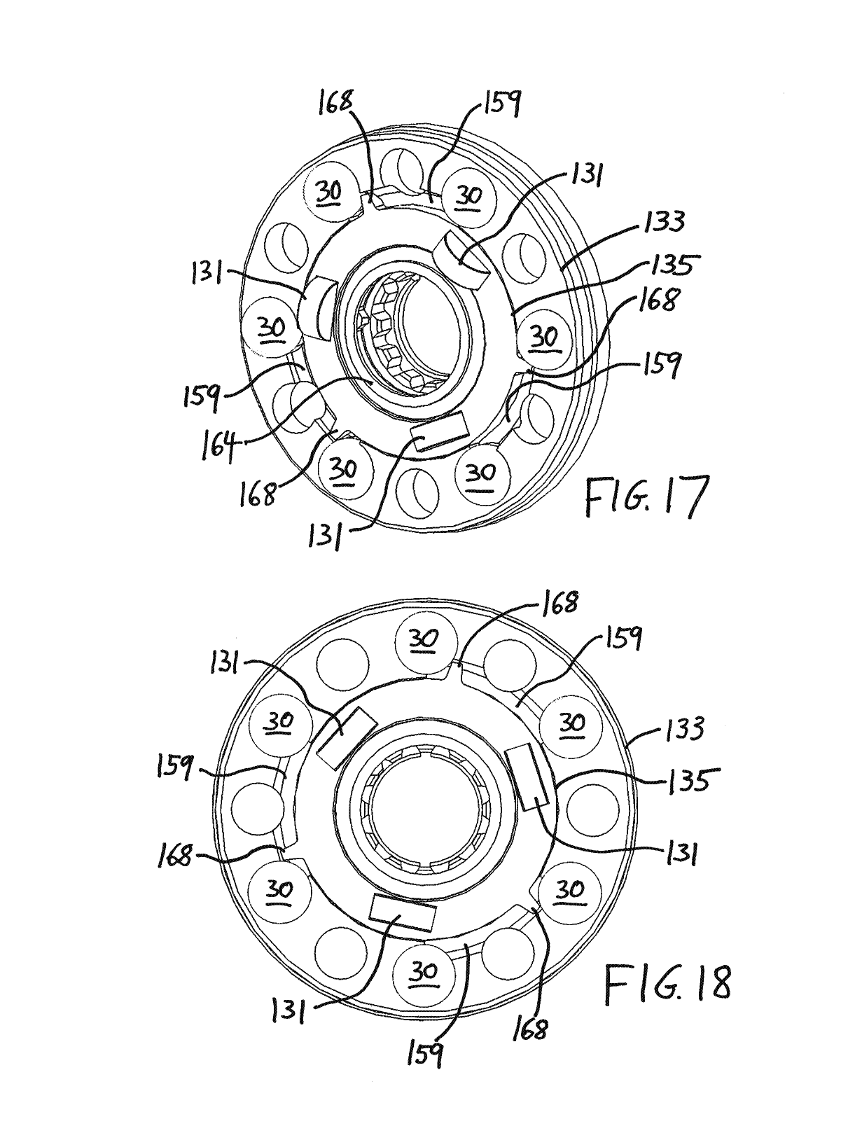

Reference is now made to FIGS. 17-18. Cage 132 of the second embodiment is a two-piece assembly comprising a radially outer cage 133 and a radially inner cage 135, wherein inner cage 135 is slidably received within an axial hole 152 of outer cage 133 to permit relative rotation between the inner and outer cages. A plurality of ball openings 158 are provided through outer cage 133 for receiving and retaining balls 30 in an angularly spaced arrangement around the shaft axis. A plurality of arc-segment coupling recesses 159 are arranged around an edge of axial hole 152 facing driving surface 138.

Inner cage 135 has a central mounting hole 164 for mounting the inner cage on shaft 12. Inner cage 135 also has a plurality of roller openings 166 angularly spaced about the shaft axis for receiving a plurality of rollers 131. In the figures, rollers 131 are illustrated as being cylindrical rollers to readily distinguish them from balls 30, however rollers 131 may also be embodied as spherical rollers (balls). Regardless of the shape that rollers 131 take, the diameter of rollers 131 is selected to be the same as or slightly greater than the diameter of balls 30. Finally, inner cage 135 includes a plurality of coupling tabs 168 each projecting radially outward for receipt within an associated coupling recess 159 of outer cage 133.

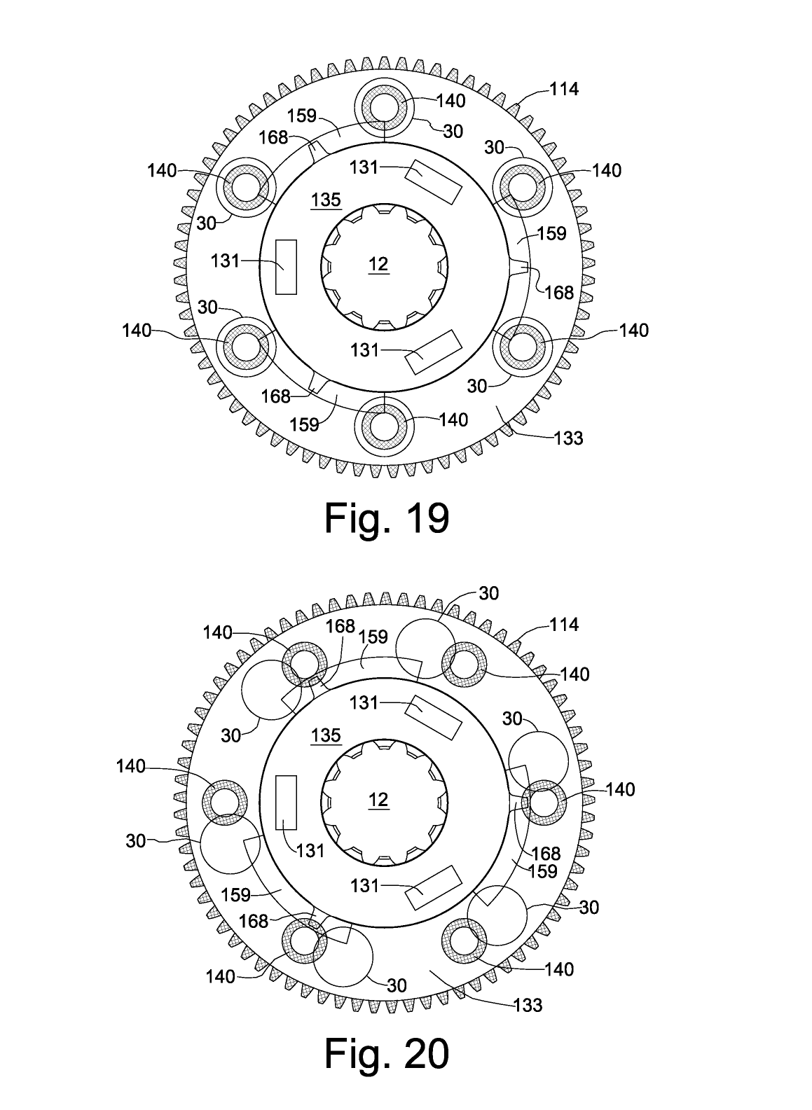

Operation of the breakout means of the second embodiment will now be explained with reference to FIGS. 19-25. FIG. 19 shows the relative arrangement of input gear 114, outer cage 133, inner cage 135, and balls 30 in an initial angular “set” position about the axis of shaft 12 prior to a breakout event. Balls 30 are aligned with pockets 140 of input gear 114 and also with pockets 150 of backing plate 128 (not shown in FIGS. 19-25). Outer cage 133 is arranged to contain balls 30 within ball openings 158 Inner cage 135 is arranged such that its coupling tabs 168 extend into respective coupling recesses 159 of outer cage 133 with clearance in both angular directions from ends of the recess 159. Shaft 12 is rotating CW about its axis at high RPM, e.g. in the neighborhood of 2400 RPM.

FIG. 20 illustrates the onset of a breakout event when output gear 16, shaft 12, and backing plate 128 are unexpectedly and suddenly stopped from rotation when the EMA hits a hard mechanical stop. Input gear 114 continues to rotate in the CW direction (a 30° CW rotation is illustrated). Outer cage 133, situated between rotating input gear 114 and stationary backing plate 128 and carrying balls 30, rotates 15° CW. Balls 30 roll out of pockets 140 and 150 and come into rolling contact with driving surface 138 and detent surface 148. As may be understood, balls 30 now carry the axial load of spring 20, and input gear 114 is displaced slightly in the second axial direction against the spring force Inner cage 135 carrying rollers 131 remains in the same angular position.

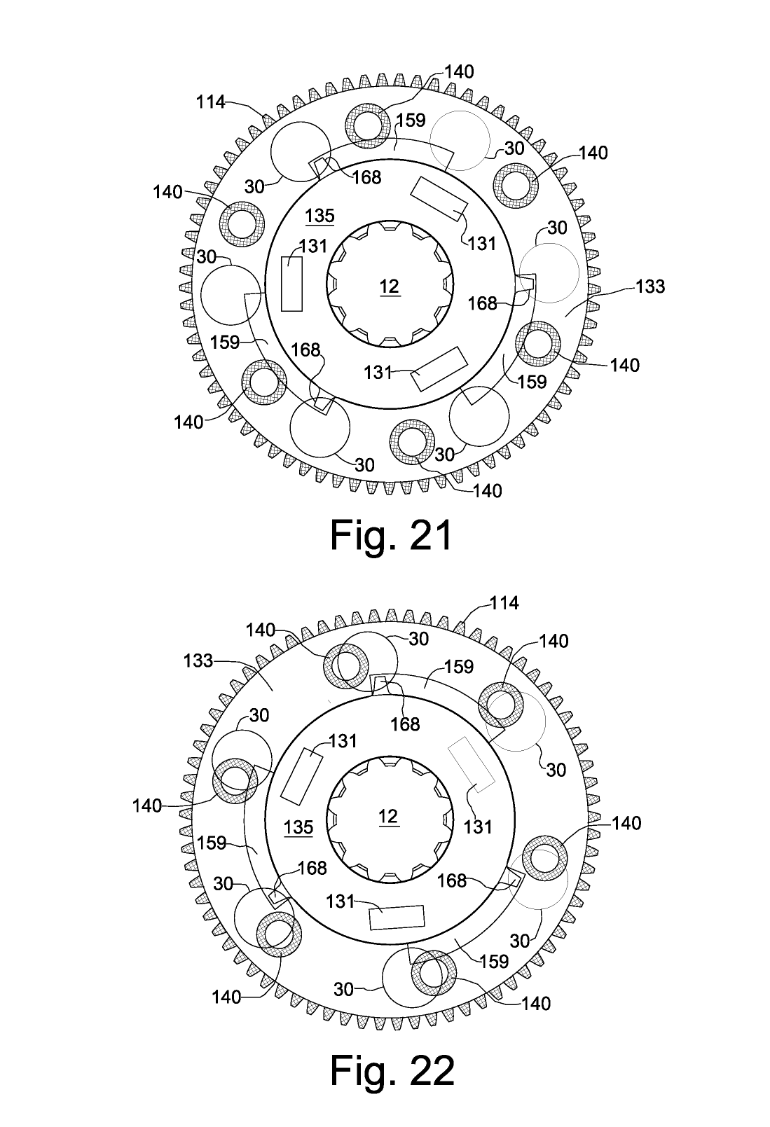

The breakout event continues in FIG. 21. Input gear 114 continues its CW rotation (a further 22° CW rotation is illustrated). Outer cage 133 and balls 30 rotate another 11° in the CW direction. At this point, respective ends of coupling recesses 159 come into contact with coupling tabs 168 of inner cage 135, which heretofore has been stationary.

FIG. 22 illustrates continuation of the breakout event. Input gear 114 continues its CW rotation (a further 52° CW rotation is illustrated; total rotation is now 104 ° CW). Outer cage 133 and balls 30 rotate an additional 26° in the CW direction, for a total rotation of 52° CW. As outer cage 133 rotates, the engagement of coupling tabs 168 with ends of coupling recesses 159 causes inner cage 135 to rotate together with outer cage 133. Thus, FIG. 22 illustrates 26° CW rotation of inner cage 135 and confined rollers 131. As may be understood, the rotation of inner cage 135 relative to stationary backing plate 128 causes rollers 131 to roll out of roller pockets 151 in backing plate 128. When this happens, rollers 131 come into rolling contact with driving surface 138 and detent surface 148. The diameter of rollers 131 is chosen to be the same as or slightly greater than the diameter of balls 30 so that rollers 131 will assume axial loading of spring 20 from balls 30.

As may be understood, input gear 114 will continue to rotate in the CW direction until the EMA's control electronics have received a signal that actuator output is not moving and sent a motor stop command to cease driving input gear 114. This may take on the order of 100-200 msec. Assuming an initial speed of 2400 RPM (40 revs per second), approximately eight revolutions of input gear 114 may be expected. During these revolutions, outer cage 133 and inner cage 135 will also rotate about shaft 12 such that rollers 131 will periodically reenter roller pockets 151 and spring loading will be momentary transferred back onto balls 30. Thus, balls 30 and rollers 131 will alternate in taking up the spring load during post-breakout rotations. In order to prevent damage or at least reduce the risk of damage, it may be advantageous to use special non-galling stainless steel (Nitronic 60) or another material suitable for braking or sustained frictional heating for inner cage 135, which is spring loaded against the backing plate 128 with about 600 pounds of force. An oil bath lubrication of assembly 110 may also be used to prevent or minimize damage to moving parts.

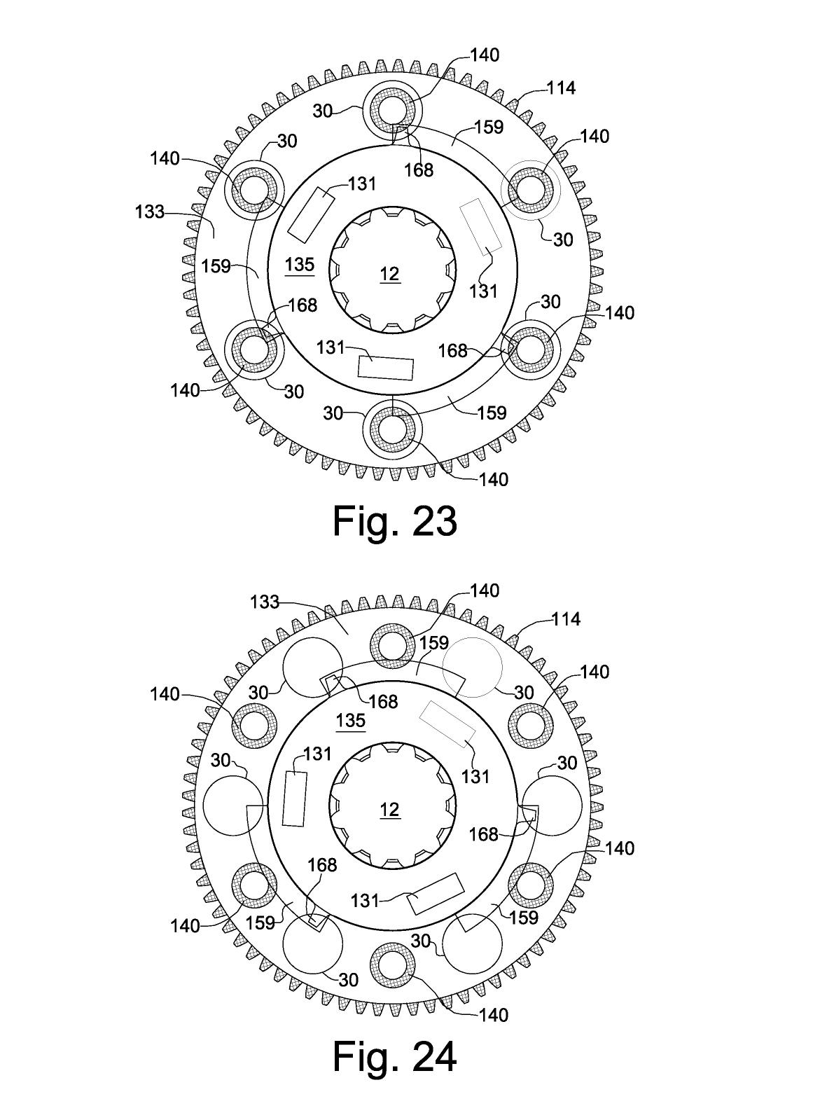

FIG. 23 shows an arbitrary rotational position at which rotation of input gear 114 is stopped by the EMA control electronics. Input gear 114 is at an angular position 120° CW from its original set position. Outer cage 133 and balls 30 are at a an angular position 60° CW from their original set position. Inner cage 135 and rollers 131 are at an angular position 34° CW from their original set position. In the position, outer cage 133 and balls 30 are centered over both sets of pockets 140 and 150, and rollers 131 carry all the axial spring load. With input gear 114 stopped, the breakout event is complete. In accordance with the present invention, assembly 110 can be reset in a relatively simple manner by commanding reverse rotation of input gear 114.

FIG. 24 depicts the beginning of the reset process in which input gear 114 is rotated CCW by 60° from its stopped position in FIG. 23 by commanding the EMA. Outer cage 133, balls 30, inner cage 135 and rollers 131 are rotated CCW by 30° from their stopped position in FIG. 23. At this point, rollers 131 return to roller pockets 151 and balls 30 assume the axial spring load.

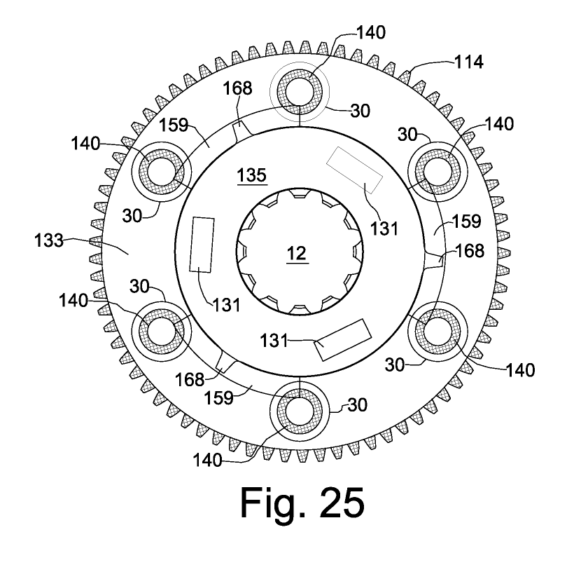

FIG. 25 shows the completed reset position achieved by commanding an additional 60° CCW rotation of input gear 114. Outer cage 133 and balls 30 rotate another 30° CCW, whereas inner cage 135 is left in the position shown in FIG. 24, thereby substantially centering coupling tabs 168 in the associated coupling recesses 159. The outer cage 133 and balls 30 are aligned with ball pockets 140 and 150, and spring 20 resets the mechanism so that the EMA is once again operational.

It will be appreciated that the present invention prevents repeated events in which the balls roll out of their pockets and are then slammed back into another pocket. This improvement is accomplished in a very compact space envelope. Other approaches may accomplish the same functionality, but they use mechanisms requiring larger physical volume.

### LIST OF REFERENCE SIGNS

10 torque-limiting assembly, first embodiment

12 shaft

14 input gear

16 output gear

18 splined end of shaft

19 retaining groove of shaft

20 spring

22 washers

24 collar

26 retainer clips

28 backing plate

30 balls

32 cage

34 input gear mounting sleeve

36 input gear annular recess

38 input gear driving surface

40 input gear ball pockets

42 input gear ramps

44 input gear slots

46 backing plate toothed opening

48 backing plate detent surface

50 backing plate ball pockets

52 cage mounting hole

54 cage driven surface

56 cage braking surface

58 cage ball openings

60 cage ramps

62 cage slots

110 torque-limiting assembly, second embodiment

114 input gear, second embodiment

128 backing plate, second embodiment

131 rollers

132 composite cage

133 outer cage

135 inner cage

138 input gear driving surface, second embodiment

140 input gear ball pockets, second embodiment

148 backing plate ball detent surface, second embodiment

150 backing plate ball pockets, second embodiment

151 backing plate roller pockets

152 outer cage axial hole

158 outer cage ball openings

159 outer cage coupling recesses

164 inner cage mounting hole

166 inner cage roller openings

168 inner cage coupling tabs

1. A torque-limiting assembly comprising:
a shaft rotatable about a shaft axis;
a gear mounted on the shaft so as to be rotatable about the shaft axis relative to the shaft, the gear including a driving surface having a plurality of ball pockets angularly spaced about the shaft axis;
a backing plate mounted on the shaft so as to rotate with the shaft, the backing plate including a detent surface opposing the driving surface and having a plurality of ball pockets angularly spaced about the shaft axis;
at least one of the gear and the backing plate being axially displaceable along the shaft;
at least one spring arranged to provide an axially-directed load opposing axial separation of the gear relative to the backing plate;
a cage mounted on the shaft between the driving surface of the gear and the detent surface of the backing plate, the cage including a driven surface facing the driving surface and a braking surface facing the detent surface, the cage further including a plurality of ball openings angularly spaced about the shaft axis;
a plurality of balls of a uniform diameter respectively received in the plurality of ball openings, wherein the diameter of the balls is greater than an axial thickness of the cage from the driven surface to the braking surface such that protruding spherical caps of each ball project into a corresponding one of the ball pockets in the driving surface and an opposing one of the ball pockets in the detent surface;
wherein torque is transmitted between the gear and the shaft such that the gear and the shaft rotate together about the shaft axis when the transmitted torque does not exceed a torque limit, and wherein there is relative rotation between the gear and the shaft when the torque limit is exceeded causing the plurality of balls to roll out of the ball pockets in the driving surface and the detent surface, whereby the balls separate the driving surface and the detent surface by an axial separation distance corresponding to the ball diameter against the urging of the at least one spring; and
breakout means for maintaining at least the axial separation distance while the relative rotation between the gear and the shaft continues once the torque limit has been exceeded.

2. The torque-limiting assembly according to claim 1, wherein the gear is an input gear driven by a motor and the shaft connects the input gear to an output gear rigidly mounted on the shaft, wherein the torque limit is exceeded in response to a mechanical stop event halting rotation of the shaft about the shaft axis.

3. The torque-limiting assembly according to claim 1, wherein the gear is axially displaceable along the shaft in first and second opposite axial directions, the at least one spring urges the gear in the first axial direction toward the backing plate, and the backing plate is constrained against axial displacement along the shaft in the first axial direction.

4. The torque-limiting assembly according to claim 3, wherein the breakout means comprises:
a circular series of ramps protruding out of the driving surface of the gear and angularly spaced about the shaft axis, wherein the ramps protruding out of the driving surface are separated from one another by arc-shaped slots in the driving surface; and
a corresponding circular series of ramps protruding out of the driven surface of the cage, wherein the ramps protruding out of the driven surface are separated from one another by arc-shaped slots in the driven surface;
wherein as the gear rotates about the shaft axis relative to the shaft incident to the torque limit being exceeded, the ramps protruding out of the driving surface engage the ramps protruding out of the driven surface to maintain at least the axial separation distance.

5. The torque-limiting assembly of claim 4, wherein the engagement of the ramps protruding out of the driving surface with the ramps protruding out of the driven surface causes the driving surface and the detent surface to be separated by an axial distance greater than the diameter of the balls, wherein the balls are freed from the axially-directed spring load.

6. The torque-limiting assembly of claim 4, wherein the engagement of the ramps protruding out of the driving surface with the ramps protruding out of the driven surface causes the cage to rotate in unison with the gear.

7. The torque-limiting assembly of claim 6, wherein the engagement of the ramps protruding out of the driving surface with the ramps protruding out of the driven surface displaces the cage in the first axial direction such that the braking surface of the cage comes into frictional contact with the detent surface of the backing plate.

8. The torque-limiting assembly according to claim 3, wherein the breakout means comprises:
a plurality of rollers angularly spaced about the shaft axis, the plurality of rollers being respectively received in a plurality of roller pockets in the detent surface of the backing plate and in a plurality of roller openings in the cage;
the cage having a radially outer cage portion and a radially inner cage portion coupled to one another such that relative rotation between the outer and inner cage portions is permitted through a limited angle and when the angle is reached in a given rotational direction the inner and outer cage portions rotate together with one another, wherein one of the inner and outer cage portions carries the plurality of rollers and the other of the inner and outer cage portions carries the plurality of balls;
wherein as the gear rotates relative to the shaft and the backing plate incident once the torque limit is exceeded, the other cage portion carrying the balls rotates relative to the shaft proportionally to the rotation of the gear relative to the shaft and rotates relative to the one cage portion carrying the rollers until the limited angle is reached and the cage portions rotate together, wherein rotation of the one cage portion relative to the backing plate causes the plurality of rollers to roll out of the roller pockets in the detent surface and come into rolling contact with the driving surface and the detent surface to maintain at least the axial separation distance.

9. The torque-limiting assembly according to claim 8, wherein the inner cage portion carries the plurality of rollers and the outer cage portion carries the plurality of balls.

10. The torque-limiting assembly according to claim 8, wherein the inner cage portion and the outer cage portion are coupled together by at least one tab received in an arc-segment recess.

11. The torque-limiting assembly according to claim 1, wherein the breakout means is reversible to reset the assembly by commanding a reverse rotation of the gear.

12. A torque-limiting assembly comprising:
a shaft rotatable about a shaft axis;
a gear mounted on the shaft so as to be rotatable about the shaft axis relative to the shaft, the gear including a driving surface having a plurality of ball pockets angularly spaced about the shaft axis;
a backing plate mounted on the shaft so as to rotate with the shaft, the backing plate including a detent surface opposing the driving surface and having a plurality of ball pockets angularly spaced about the shaft axis;
at least one of the gear and the backing plate being axially displaceable along the shaft;
at least one spring arranged to provide an axially-directed load opposing axial separation of the gear relative to the backing plate;
a cage mounted on the shaft between the driving surface of the gear and the detent surface of the backing plate, the cage including a driven surface facing the driving surface and a braking surface facing the detent surface, the cage further including a plurality of ball openings angularly spaced about the shaft axis;
a plurality of balls of a uniform diameter respectively received in the plurality of ball openings, wherein the diameter of the balls is greater than an axial thickness of the cage from the driven surface to the braking surface such that protruding spherical caps of each ball project into a corresponding one of the ball pockets in the driving surface and an opposing one of the ball pockets in the detent surface; and
a plurality of separation members actuated by relative rotation between the gear and the cage, wherein the separation members are arranged to act between the driving surface of the gear and the detent surface of the backing plate to separate the driving surface and the detent surface by a distance at least as great as the diameter of the balls.

13. The torque-limiting assembly according to claim 12, wherein the plurality of separation members includes corresponding pairs of ramp members protruding from the driving surface of the gear and the driven surface of the cage.

14. The torque-limiting assembly according to claim 12, wherein the plurality of separation members includes a plurality of rollers carried by the cage.

15. The torque-limiting assembly according to claim 12, wherein actuation of the plurality of separation members is reversible to reset the assembly by commanding a reverse rotation of the gear.

16. In a torque-limiting assembly wherein a plurality of balls roll out of respective opposing ball pockets in opposing surfaces of a gear and a backing plate when a torque limit is exceeded to enable relative rotation between the gear and the backing plate by rolling engagement of the balls with the opposing surfaces, wherein the opposing surfaces are biased toward one another by axially directed spring loading, the improvement comprising:
at least one separation member arranged to keep the opposing surfaces separated by an axial distance at least as great as a diameter of the balls during intermittent alignment of the balls with the opposing ball pockets during the relative rotation.

17. The improvement according to claim 16, wherein the at least one separation member includes a pair of ramp members respectively protruding from the opposing surfaces to engage one another.

18. The improvement according to claim 16, wherein the at least one separation member includes a roller engaging the opposing surfaces, wherein the roller is not aligned with any of the opposing ball pockets throughout all relative rotational positions between the gear and the backing plate.
